(19) United States
(12) Patent Application Publication
(10) Pub. No.: US 2022/0053126 A1
(43) Pub. Date: Feb. 17, 2022

(54) PHOTOGRAPHING APPARATUS, UNMANNED AERIAL VEHICLE, CONTROL TERMINAL AND METHOD FOR PHOTOGRAPHING

(71) Applicant: SZ DJI TECHNOLOGY CO., LTD., Shenzhen (CN)

(72) Inventors: Dongxiang ZHAO, Shenzhen (CN); Bo WANG, Shenzhen (CN); Wenjian HUANG, Shenzhen (CN); Chao ZHU, Shenzhen (CN)

(73) Assignee: SZ DJI TECHNOLOGY CO., LTD., Shenzhen (CN)

(21) Appl. No.: 17/513,870

(22) Filed: Oct. 28, 2021

Related U.S. Application Data
(63) Continuation of application No. PCT/CN2019/087116, filed on May 15, 2019.

(51) Int. Cl. H04N 5/232; H04N 7/18; G06T 9/00; B64C 39/02; B64D 47/08

(52) U.S. Cl. CPC H04N 5/23229; H04N 7/183; G06T 9/00; B64C 2201/127; B64C 39/024; B64D 47/08; H04N 5/23203

(57) ABSTRACT

This application provides a photographing apparatus, an unmanned aerial vehicle (UAV), a control terminal, and a method for photographing. The photographing apparatus includes an image sensor, a display screen, a random-access memory (RAM), a storage device, a processor and an instruction stored in the memory and executable by the processor. The processor executes the instruction to implement: receiving a continuous-shooting command; partitioning the RAM according to the continuous-shooting command to obtain an at least one buffering storage space; controlling the image sensor to obtain original image data; storing the original image data in the at least one buffering storage space; and controlling the display screen to display image data generated according to original image data. The technical solution provided in this application improves a continuous shooting speed, and implements a Quick view function during continuous shooting, so that the photographing apparatus provides good user experience during continuous shooting.

### RELATED APPLICATIONS

The present patent document is a continuation of PCT Application No. PCT/CN2019/087116, filed on May 15, 2019, and the content of which is incorporated herein by reference in its entirety.

### TECHNICAL FIELD

The present disclosure relates to the technical field of photographing apparatuses, and specifically, to a photographing apparatus, an unmanned aerial vehicle (UAV), a UAV control terminal, and a method for photographing.

### BACKGROUND

A photographing apparatus usually has a Quick view function. The Quick view function is, during a timed shooting mode, the photographing apparatus continuously displays a previously photographed picture on its display before the next picture is taken. The photographing apparatus further has a Live view function, that is, the photographing apparatus continuously displays a viewfinder image obtained by a sensor.

However, it is difficult for a current photographing apparatus to implement a fast continuous shooting due to a hardware limitation, and it is difficult to implement the Quick view function during fast continuous shooting. Consequently, the user interaction is relatively poor during the fast continuous shooting.

### BRIEF SUMMARY

The present disclosure aims to resolve at least one of technical problems in the existing technology.

Thus, in some exemplary embodiments of the present disclosure, a photographing apparatus is provided. The photographing apparatus includes: at least one image sensor; at least one display screen; at least one transitory storage medium; at least one non-transitory storage medium, storing at least one set of instructions; at least one processor in communication with the at least one transitory storage medium and the at least one non-transitory storage medium, the at least one image sensor, and the at least one display screen, wherein during operation, the at least one processor execute the at least one set of instructions to: receive a continuous-shooting command, partition the transitory storage medium according to the continuous-shooting command to obtain an at least one buffering storage space, control the image sensor to obtain original image data, store the original image data in the at least one buffering storage space, and control the display screen to display image data generated according to the original image data.

In some exemplary embodiments of the present disclosure, a method for photographing is provided. The method for photographing includes: receiving a continuous-shooting command; partitioning a transitory storage medium of a photographing apparatus according to the continuous-shooting command to obtain an at least one buffering storage space; obtaining original image data; storing the original image data in the at least one buffering storage space; and displaying image data generated according to the original image data.

### BRIEF DESCRIPTION OF THE DRAWINGS

The foregoing and/or additional aspects and advantages of the present disclosure will become apparent and readily understandable from the descriptions of the exemplary embodiments with reference to the following accompanying drawings.

FIG. 1 is a structural block diagram of a photographing apparatus according to some exemplary embodiments of the present disclosure;

FIG. 2 is a structural block diagram of an unmanned aerial vehicle (UAV) according to some exemplary embodiments of the present disclosure;

FIG. 3 is a structural block diagram of a UAV control terminal according to some exemplary embodiments of the present disclosure;

FIG. 4 is a flowchart of a method for photographing according to some exemplary embodiments of the present disclosure;

FIG. 5 is a flowchart of a method for photographing according to some exemplary embodiments of the present disclosure;

FIG. 6 is a flowchart of a method for photographing according to some exemplary embodiments of the present disclosure;

FIG. 7 is a flowchart of a method for photographing according to some exemplary embodiments of the present disclosure;

FIG. 8 is a flowchart of a method for photographing according to some exemplary embodiments of the present disclosure;

FIG. 9 is a flowchart of a method for photographing according to some exemplary embodiments of the present disclosure;

FIG. 10 is a flowchart of a method for photographing according to some exemplary embodiments of the present disclosure; and

FIG. 11 is a flowchart of a method for photographing according to some exemplary embodiments of the present disclosure.

### DETAILED DESCRIPTION

To more clearly understand the objectives, features and advantages of the present disclosure, the following further describes this application in detail with reference to the accompanying drawings and exemplary embodiments. It should be noted that, if there is no conflict, the exemplary embodiments of this application and features in the exemplary embodiments may be mutually combined.

Many specific details are described in the following descriptions to facilitate understanding of the present disclosure. However, the present disclosure may be further implemented in other manners different from those described herein. Therefore, the protection scope of this application is not limited by the exemplary embodiments disclosed below.

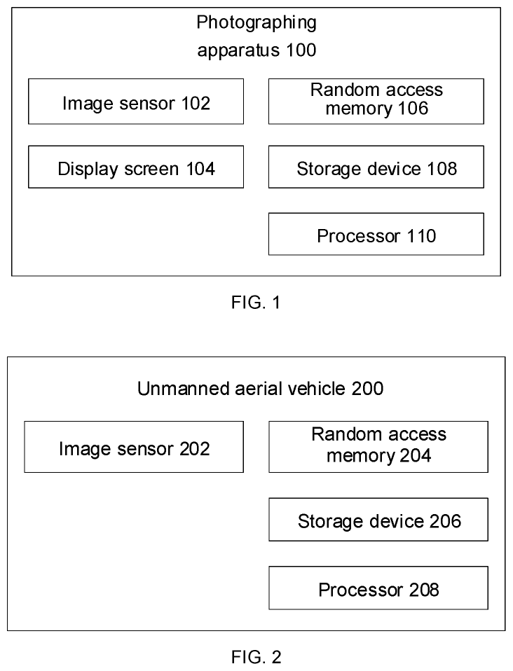

The following describes, with reference to FIG. 1 to FIG. 11, a photographing apparatus, an unmanned aerial vehicle (UAV), a UAV control terminal, and a method for photographing according to some exemplary embodiments of the present disclosure.

As shown in FIG. 1, in some exemplary embodiments of the present disclosure, a photographing apparatus 100 is provided. The photographing apparatus may include an image sensor 102, a display screen 104, a random-access memory (RAM) 106, a storage device 108 (i.e., a non-transitory storage medium), a processor 110 and an instruction stored in the storage device and may be executed by the processor. The processor 110 may execute the instruction to implement: receiving a continuous-shooting command, and partitioning the RAM according to the continuous-shooting command to obtain an at least one buffering storage space; controlling the image sensor to obtain original image data, storing the original image data in the at least one buffering storage space; and controlling the display screen to display image data generated according to the original image data.

In some exemplary embodiments of the present disclosure, when receiving the continuous-shooting command, before the shooting starts, the photographing apparatus 100 may first partitioning the RAM 106 of the photographing apparatus 100 according to the continuous-shooting command to obtain at least one buffering storage space. A size of the at least one buffering storage space may be determined according to a time interval and a number of shooting times that correspond to the continuous-shooting command. After the shooting starts, the image sensor 102 may start to obtain original image data (in some exemplary embodiments of the present disclosure, an original image file in a RAW format) of a first photograph. After obtaining the original image data of the first photograph, the original image data may be stored in the at least one buffering storage space. Because the at least one buffering storage space is obtained by partitioning the RAM 106 and has an extremely high write speed. In the existing technology, the original image data is directly stored in a storage device 108 (for example, an Hard Disk Drive (HDD) or an Secure Digital (SD) card, which has a relatively large capacity but has a relatively low write speed) By utilizing the at least one buffering storage space partitioned from the RAM 16, a data write speed is higher, and a time required for writing the data into the at least one buffering storage space is shorter. Therefore, the shooting of the next photograph may start sooner, thereby improving a continuous shooting speed. In addition, because the original image data is stored in the at least one buffering storage space (the RAM 106), a read speed is also relatively high. Therefore, the processor 110 of the photographing apparatus 100 may directly read the image data generated according to the original image data in the buffering storage space, and control the display screen 104 to display the image data. This implements a Quick view function during continuous shooting, so that the photographing apparatus 100 provides good user interaction during continuous shooting.

In some exemplary embodiments of the present disclosure shown in FIG. 1, a process in which the processor 110 executes the instruction to control the image sensor 102 to obtain original image data may include: obtaining a continuous-shooting time interval according to the continuous-shooting command, and controlling the image sensor 102 to obtain the original image data according to the time interval.

In some exemplary embodiments of the present disclosure, the continuous-shooting command may include the continuous-shooting time interval, that is, a time interval between a time at which an N^{th} image is taken and a time at which an (N+1)^{th} image is taken. The image sensor 102 may be controlled, according to the continuous-shooting time interval, to obtain the original image data, and store the original image data in the at least one of buffering storage space in order, to implement continuous shooting.

In some exemplary embodiments of the present disclosure as shown in FIG. 1, the processor 110 may execute the instruction, to implement: generating corresponding intermediate image data according to the original image data, storing the intermediate image data in the at least one buffering storage space, generating image data according to the intermediate image data; deleting the original image data in the at least one buffering storage space, and displaying the image data generated according to the intermediate image data.

In some exemplary embodiments of the present disclosure, after original data of any image is stored in the at least one buffering storage space, corresponding intermediate image data may be generated according to the original data. Generally, the intermediate image data may be in a YUV format (a color encoding format). After the intermediate image data is generated, the intermediate image data is correspondingly stored in the at least one buffering storage space. In addition, corresponding image data may be generated according to the intermediate image data. In some exemplary embodiments of the present disclosure, the image data generated according to the intermediate image data may be RGB image data. Finally, when the RGB image data is displayed, the corresponding original image data may be deleted in the at least one buffering storage space, to release storage space of the at least one buffering storage space.

In some exemplary embodiments of the present disclosure shown in FIG. 1, the processor 110 may execute the instruction to implement: generating corresponding target image data according to the intermediate image data, and storing the target image data in the at least one buffering storage space; and deleting the intermediate image data in the at least one buffering storage space.

In some exemplary embodiments of the present disclosure, after the intermediate image data (in some exemplary embodiments of the present disclosure, data in the YUV format) of any image is stored in the at least one buffering storage space, corresponding target image data may be generated according to the intermediate image data. Generally, the target image data may be an image file in a JPEG (Joint Photographing Experts Group, which is a common image format) format. After the target image data is generated, the target image data may be correspondingly stored in the at least one buffering storage space. In addition, the corresponding intermediate image data may be deleted in the at least one buffering storage space, to release storage space of the at least one buffering storage space.

The target image data (that is, data in the JPEG format) is only used for storage, and the target image data does not need to be displayed.

In some exemplary embodiments of the present disclosure shown in FIG. 1, the photographing apparatus 100 may further include an encoder. A process in which the processor 110 executes the instruction to implement generating corresponding target image data according to the intermediate image data may include: obtaining image processing information according to the continuous-shooting command; and controlling the encoder to encode the intermediate image data according to the image processing information, to generate the target image data.

In some exemplary embodiments of the present disclosure, the continuous-shooting command may include the image processing information, and may include an imaging direction (for example, a forward direction, a reverse direction, a horizontal direction, a vertical direction, or a mirror flip) of the target image data. The processor of the photographing apparatus 100 may encode the intermediate image data according to the image processing information, and finally obtains the target image data corresponding to the image processing information.

In some exemplary embodiments of the present disclosure shown in FIG. 1, the processor 110 may execute the instruction, to implement: storing each piece of target image data in the storage device 108 according to an order in which the target image data is generated, and correspondingly deleting the target image data in the at least one buffering storage space in that order.

In some exemplary embodiments of the present disclosure, the multiple pieces of target image data in the at least one buffering storage space may be stored in the storage device 108 in a sequential order according to the order in which the multiple pieces of target image data are generated. In some exemplary embodiments of the present disclosure, compared with the at least one buffering storage space (the RAM 106), the storage device 108 has a relatively low data write speed. Therefore, as a continuous-shooting process is performed, the multiple pieces of target image data may accumulate in the at least one buffering storage space. A to-be-stored queue is generated based on a time order (that is, a sequential order in which the photographs are taken) in which the multiple pieces of target image data are generated. In addition, the multiple pieces of target image data may be stored in the storage device 108 in a sequential order based on the to-be-stored queue. Each time after a piece of target image data in the queue is successfully stored in the storage device 108, the corresponding piece of target image data may be deleted in the queue to free up the at least one buffering storage space.

In some exemplary embodiments of the present disclosure shown in FIG. 1, the at least one buffering storage space may include a first buffering storage space, a second buffering storage space and a third buffering storage space. The original image data may be stored in the first buffering storage space, the intermediate image data may be stored in the second buffering storage space, and the target image data may be stored in the third buffering storage space.

In some exemplary embodiments of the present disclosure, the at least one buffering storage space may include a first buffering storage space, which may be denoted as a RAW buffer; a second buffering storage space, which may be denoted as a YUV buffer; and a third buffering storage space, which may be denoted as a JPEG buffer. The first buffering storage space (the RAW buffer) may be configured to buffer the original image data (RAW), the second buffering storage space (the YUV buffer) may be configured to buffer the intermediate image data (YUV), and the third buffering storage space may be configured to buffer the target image data (JPEG).

The third buffering storage space may be obtained by partitioning the RAM, or may be obtained by partitioning external storage space such as an HDD and/or an SD card.

In some exemplary embodiments of the present disclosure shown in FIG. 1, the processor 110 may execute the instruction, to implement: obtaining respective data sizes in a first buffering storage space, a second buffering storage space and a third buffering storage space, and separately adjusting storage capacities of the first buffering storage space, the second buffering storage space and the third buffering storage space according to the data sizes.

In some exemplary embodiments of the present disclosure, the processor 110 of the photographing apparatus 100 may monitor, in real time, the size of corresponding image data in the first buffering storage space, the second buffering storage space and the third buffering storage space, and dynamically adjusts the storage capacities of the first buffering storage space, the second buffering storage space and the third buffering storage space according to the size of the corresponding image data. In some exemplary embodiments of the present disclosure, if a size of original image data in the first buffering storage space is relatively small, and the first buffering storage space is relatively idle, a storage capacity of the first buffering storage space may be correspondingly reduced; if a size of target image data in the third buffering storage space is relatively large, and the third buffering storage space is almost full, a storage capacity of the third buffering storage space may be correspondingly increased, to ensure utilization efficiency of space of the at least one buffering storage space.

In some exemplary embodiments of the present disclosure shown in FIG. 1, a process in which the processor 110 executes the instruction, to control the image sensor 102 to obtain original image data may include: fixing an at least one image photographing parameter of the image sensor 102, and obtaining the original image data according to the image photographing parameter.

In some exemplary embodiments of the present disclosure, when the image sensor 102 is controlled to obtain the original image data, the at least one image photographing parameter of the image sensor 102 may be first fixed, and the original image data may be obtained according to the fixed image photographing parameter. This may ensure that multiple images obtained through the continuous shooting have a consistent style, and avoid a case in which a continuous shooting speed is lowered due to wastes in performance caused by determining an at least one image photographing parameter for each photographed image during a continuous-shooting process.

In some exemplary embodiments of the present disclosure shown in FIG. 1, the at least one image photographing parameter may include at least one of: an image exposure parameter, an image focus parameter, or an image white balance parameter.

In some exemplary embodiments of the present disclosure, the at least one image photographing parameter may generally include the image exposure parameter. The exposure parameter affects image exposure (brightness) during imaging. The at least one image photographing parameter may further include the image focus parameter. The image focus parameter affects a focal point position of a photographed object in the target image data. The at least one image photographing parameter may further include the image white balance parameter. The image white balance parameter affects an overall color and tone of an obtained image.

In some exemplary embodiments of the present disclosure shown in FIG. 1, the display screen 104 may include a first display area and a second display area. The processor 110 may execute the instruction, to control the image sensor 102 to continuously obtain real-time image data; and control the display screen 104 to display real-time image data in the first display area, and control the display screen 104 to display the image data in the second display area.

In some exemplary embodiments of the present disclosure, the display screen 104 of the photographing apparatus 100 may include the first display area and the second display area. The real-time image data may be displayed in the first display area thereby implementing a Live view function. The image data may be displayed in the second display area thereby implementing a Quick view function. In some exemplary embodiments of the present disclosure, the second display area may be within the first display area.

As shown in FIG. 2, in some exemplary embodiments of the present disclosure, an UAV 200 is provided. The UAV 200 may include an image sensor 202, a RAM 204, a storage device 206 (i.e., a non-transitory storage medium), a processor 208 and an instruction that is stored in the storage device 206 and may be executed by the processor. The processor 208 may execute the instruction, to implement: receiving a continuous-shooting command, partitioning the RAM according to the continuous-shooting command to obtain an at least one buffering storage space; and controlling the image sensor to obtain original image data, storing the original image data in the at least one buffering storage space, and sending image data generated according to the original image data to a control terminal.

In some exemplary embodiments of the present disclosure, the UAV 200 may receive the continuous-shooting command from a terminal such as the control terminal or a mobile phone. When the continuous-shooting command is received, before shooting is started, the RAM 204 of the UAV 200 may be first partitioned according to the continuous-shooting command to obtain the at least one buffering storage space. A size of the at least one buffering storage space may be determined according to a time interval and a number of shooting times that correspond to the continuous-shooting command. After the shooting starts, the image sensor 202 may start to obtain original image data (in some exemplary embodiments of the present disclosure, an original image file in a RAW format) of a first photograph. After obtaining the original image data of the first photograph, the original image data may be stored in the at least one buffering storage space. Because the at least one buffering storage space is obtained by partitioning the RAM 204, and has an extremely high write speed comparing to the existing technology where original image data is directly stored in a storage device 206 (for example, an HDD or an SD storage card, which has a relatively large capacity but has a relatively low write speed), a data write speed is higher, and a time required for writing the data into the at least one buffering storage space is shorter. Therefore, the shooting of the next photography may start sooner, thereby improving a continuous shooting speed.

In some exemplary embodiments of the present disclosure, a process in which the processor 208 executes the instruction, to control the image sensor 202 to obtain original image data may include: obtaining a continuous-shooting time interval according to the continuous-shooting command, and controlling the image sensor 202 to obtain the original image data according to the time interval.

In some exemplary embodiments of the present disclosure, the continuous-shooting command may include the continuous-shooting time interval, that is, a time interval between a time at which an N^{th} image is taken and a time at which an (N+1)^{th} image is taken. The image sensor 202 may be controlled, according to the continuous-shooting time interval, to obtain the original image data, and store the original image data in the at least one buffering storage space in a sequential order, to implement continuous shooting.

In some exemplary embodiments of the present disclosure, the processor 208 may execute the instruction, to implement: generating corresponding intermediate image data according to the original image data, storing the intermediate image data in the at least one buffering storage space, and generating the image data according to the intermediate image data; and deleting the original image data in the at least one buffering storage space, and sending the image data to a control terminal.

In some exemplary embodiments of the present disclosure, after original data of any image is stored in the at least one buffering storage space, corresponding intermediate image data may be generated according to the original data. Generally, the intermediate image data may be data in a YUV format (a color encoding format). After the intermediate image data is generated, the intermediate image data may be correspondingly stored in the at least one buffering storage space. In addition, the corresponding original image data may be deleted in the at least one buffering storage space, to release storage space of the at least one buffering storage space.

In some exemplary embodiments of the present disclosure, the processor 208 may execute the instruction, to implement: generating corresponding target image data according to the intermediate image data, and storing the target image data in the at least one buffering storage space; and deleting the intermediate image data in the at least one buffering storage space.

In some exemplary embodiments of the present disclosure, after intermediate image data (in some exemplary embodiments of the present disclosure, data in a YUV format) of any image is stored in the at least one buffering storage space, corresponding target image data may be generated according to the intermediate image data. Generally, the target image data may be an image file in a JPEG (Joint Photographing Experts Group, which is a common image format) format. After the target image data is generated, the target image data may be correspondingly stored in the at least one buffering storage space. In addition, the corresponding intermediate image data may be deleted in the at least one buffering storage space, to release storage space of the at least one buffering storage space.

In some exemplary embodiments of the present disclosure, the UAV 200 may further include an encoder. A process in which the processor 208 executes the instruction, to generate corresponding target image data according to the intermediate image data may include: obtaining image processing information according to the continuous-shooting command; and controlling the encoder to encode the intermediate image data according to the image processing information, to generate the target image data.

In some exemplary embodiments of the present disclosure, the continuous-shooting command may include the image processing information, and in some exemplary embodiments of the present disclosure, may include an imaging direction (for example, a forward direction, a reverse direction, a horizontal direction, a vertical direction, or a mirror flip) of the target image data. The processor of the UAV 200 may encode the intermediate image data according to the image processing information, and may finally obtain the target image data in compliance with the image processing information.

The target image data (that is, data in the JPEG format) is only used for storage, and the target image data does not need to be displayed.

In some exemplary embodiments of the present disclosure, the processor 208 may execute the instruction, to implement: storing each piece of target image data in the storage device 206 according to an order in which multiple pieces of target image data are generated, and correspondingly deleting the target image data in the at least one buffering storage space.

In some exemplary embodiments of the present disclosure, the multiple pieces of target image data in the at least one buffering storage space may be stored in the storage device 206 in a sequential order according to the order in which the multiple pieces of target image data are generated. In some exemplary embodiments of the present disclosure, compared with the at least one buffering storage space (the RAM 204), the storage device 206 has a relatively low data write speed. Therefore, as a continuous-shooting process is performed, obtained target image data may accumulate in the at least one buffering storage space. A to-be-stored queue may be generated based on a time sequence (that is, a sequential order in which the shots are taken) in which the multiple pieces of target image data are generated. In addition, the multiple pieces of target image data may be stored in the storage device 206 in a sequential order based on the to-be-stored queue. Each time after a piece of target image data in the queue is successfully stored in the storage device 206, the piece of target image data may be deleted in the queue to release space of the at least one buffering storage space.

In some exemplary embodiments of the present disclosure, the at least one buffering storage space may include a first buffering storage space, a second buffering storage space and a third buffering storage space. The original image data may be stored in the first buffering storage space, the intermediate image data may be stored in the second buffering storage space, and the target image data may be stored in the third buffering storage space.

In some exemplary embodiments of the present disclosure, the buffering storage space may include a first buffering storage space, which may be denoted as a RAW buffer; a second buffering storage space, which may be denoted as a YUV buffer; and a third buffering storage space, which may be denoted as a JPEG buffer. The first buffering storage space (the RAW buffer) may be configured to buffer the original image data (RAW), the second buffering storage space (the YUV buffer) may be configured to buffer the intermediate image data (YUV), and the third buffering storage space may be configured to buffer the target image data (JPEG).

The third buffering storage space may be obtained by partitioning the RAM, or may be obtained by partitioning external storage space such as an HDD and/or an SD card.

In some exemplary embodiments of the present disclosure, the processor 208 of the UAV 200 may execute the instruction, to implement: obtaining respective data sizes in a first buffering storage space, a second buffering storage space and a third buffering storage space, and separately adjusting storage capacities of the first buffering storage space, the second buffering storage space and the third buffering storage space according to the data sizes.

In some exemplary embodiments of the present disclosure, the processor 208 of the UAV may monitor, in real time, the size of corresponding image data in the first buffering storage space, the second buffering storage space and the third buffering storage space, and dynamically adjusts the storage capacities of the first buffering storage space, the second buffering storage space and the third buffering storage space according to the size of the corresponding image data. In some exemplary embodiments of the present disclosure, if a size of original image data in the first buffering storage space is relatively small, and the first buffering storage space is relatively idle, a storage capacity of the first buffering storage space may be correspondingly reduced; if a size of target image data in the third buffering storage space is relatively large, and the third buffering storage space is almost full, a storage capacity of the third buffering storage space may be correspondingly increased, to ensure utilization efficiency of space of the at least one buffering storage space.

In some exemplary embodiments of the present disclosure, a process in which the processor 208 executes the instruction, to implement controlling the image sensor 202 to obtain original image data may include: fixing an at least one image photographing parameter of the image sensor 202, and obtaining the original image data according to the image photographing parameter.

In some exemplary embodiments of the present disclosure, when the image sensor 202 is controlled to obtain the original image data, the at least one image photographing parameter of the image sensor 202 may be first fixed, and the original image data may be obtained according to the fixed image photographing parameter. This may ensure that multiple images obtained through continuous shooting have a consistent style, and avoid a case in which a continuous shooting speed is lowered due to wastes in performance caused by determining an at least one image photographing parameter for each photographed image during a continuous-shooting process.

In some exemplary embodiments of the present disclosure, the at least one image photographing parameter may include at least one of: an image exposure parameter, an image focus parameter, or an image white balance parameter.

In some exemplary embodiments of the present disclosure, the at least one image photographing parameter generally may include the image exposure parameter. The exposure parameter affects image exposure (brightness) during imaging. The at least one image photographing parameter may further include the image focus parameter. The image focus parameter affects a focal point position of a photographed object in the target image data. The at least one image photographing parameter may further include the image white balance parameter. The image white balance parameter affects an overall color and tone of an obtained image.

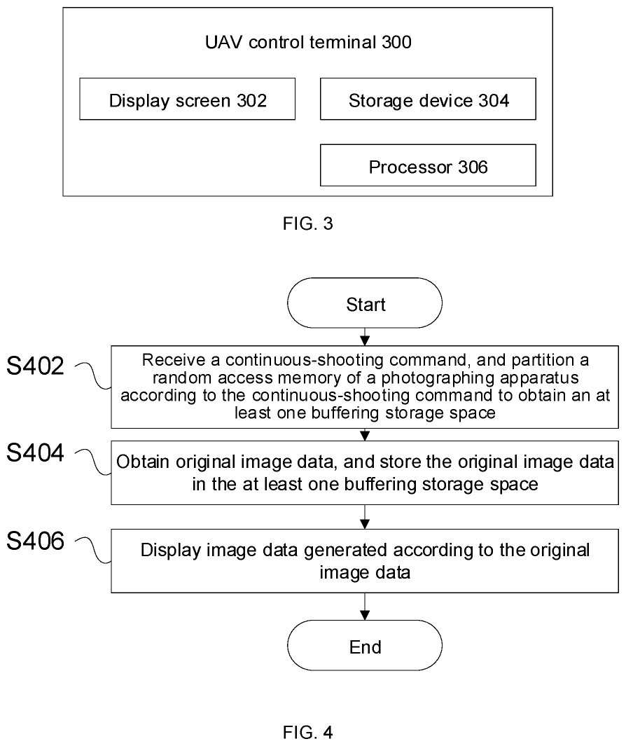

As shown in FIG. 3, in some exemplary embodiments of the present disclosure, a UAV control terminal 300 is provided. The UAV control terminal 300 may include a display screen 302, a storage device 304 (i.e., a non-transitory storage medium), a processor 306 and a instruction stored in the memory and may be executed by the processor. The processor 306 may execute the instruction, to implement: sending a continuous-shooting command to the UAV, to control an image sensor disposed on the UAV to obtain original image data; and receiving image data generated according to the original image data, and controlling the display screen to display the image data.

In some exemplary embodiments of the present disclosure, the UAV control terminal 300 may be configured to control the UAV. In some exemplary embodiments of the present disclosure, the UAV control terminal 300 may send a continuous-shooting command to the UAV, to control an image sensor disposed on the UAV to obtain image data. The UAV may receive the continuous-shooting command from a terminal such as the control terminal 300 or a mobile phone. When the continuous-shooting command is received, before the shooting starts, the RAM 304 of the UAV may be first partitioned according to the continuous-shooting command to obtain the at least one buffering storage space. A size of the at least one buffering storage space may be determined according to a time interval and a number of shooting times that correspond to the continuous-shooting command. After the shooting starts, the image sensor may start to obtain image data of a first photograph, and stores the image data in the at least one buffering storage space after obtaining the image data of the first photograph. In addition, because a read speed of the at least one buffering storage space is relatively high, the processor 306 of the UAV synchronously may obtain an image file in the at least one buffering storage space, and send the image file to the UAV control terminal 300. After receiving the image data, the UAV control terminal 300 may display the received image data on the display screen 302.

In some exemplary embodiments of the present disclosure, the continuous-shooting command may include a continuous-shooting time interval, and the UAV may control the image sensor to obtain the image data according to the time interval.

In some exemplary embodiments of the present disclosure, the continuous-shooting command may include the continuous-shooting time interval, that is, a time interval between a time at which an N^{th} image is taken and a time at which an (N+1)^{th} image is taken. The UAV may be controlled, according to the continuous-shooting time interval, to continuously obtain the image data, to implement continuous shooting.

In some exemplary embodiments of the present disclosure, the display screen 302 may include a first display area and a second display area. The processor 306 may execute the instruction, to implement: continuously receiving real-time image data sent by the UAV; and controlling the display screen 302 to display the real-time image data in the first display area, and controlling the display screen 302 to display the image data in the second display area.

In some exemplary embodiments of the present disclosure, the display screen 302 of the UAV control terminal 300 may include the first display area and the second display area. The real-time image data may be displayed in the first display area, that is, a Live view function may be implemented. The image data may be displayed in the second display area, that is, a Quick view function may be implemented. In some exemplary embodiments of the present disclosure, the second display area may be within the first display area.

As shown in FIG. 4, in some exemplary embodiments of the present disclosure, a method for photographing is provided. The method may include:

S402: Receive a continuous-shooting command, and partition a RAM of a photographing apparatus according to the continuous-shooting command to obtain an at least one buffering storage space.

S404: Obtain original image data, and store the original image data in the at least one buffering storage space.

S406: Display image data generated according to the original image data.

In some exemplary embodiments of the present disclosure, when receiving the continuous-shooting command, before the shooting starts, the RAM may be first partitioned according to the continuous-shooting command to obtain the at least one buffering storage space. A size of the at least one buffering storage space may be determined according to a time interval and a number of shooting times that correspond to the continuous-shooting command. After the shooting starts, the image sensor may start to obtain original image data (in some exemplary embodiments of the present disclosure, an original image file in a RAW format) of a first photograph. After obtaining the original image data of the first photograph, the original image data may be stored in the at least one buffering storage space. Because the at least one buffering storage space is obtained by partitioning the RAM, and has an extremely high write speed, comparing to the existing technology where the original image data is directly stored in a memory (for example, an HDD or an SD storage card, which has a relatively large capacity but has a relatively low write speed), a data write speed is higher, and a time required for writing the data into the at least one buffering storage space is shorter. Therefore, the shooting of the next photography may start sooner, thereby improving a continuous shooting speed. In addition, because the original image data is stored in the buffering storage space (the RAM), a read speed is also relatively high. Therefore, the processor may directly read the image data generated according to the original image data in the at least one buffering storage space, and control the display screen to display the image data generated according to the original image data. This implements a Quick view function during continuous shooting, and provides good user interactions during continuous shooting.

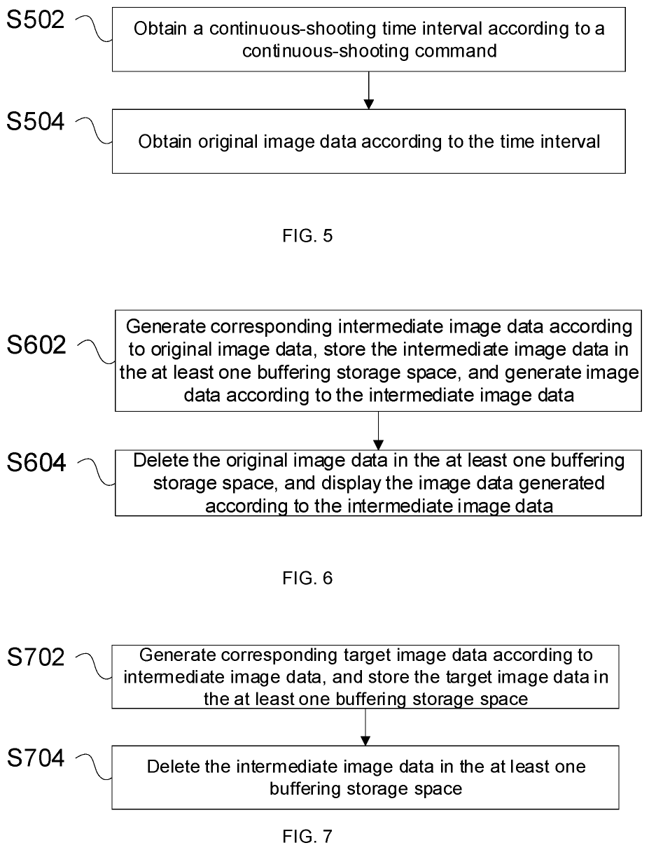

In some exemplary embodiments of the present disclosure, as shown in FIG. 5, a method for photographing may further include:

S502: Obtain a continuous-shooting time interval according to a continuous-shooting command.

S504: Obtain original image data according to the time interval.

In some exemplary embodiments of the present disclosure, the continuous-shooting command may include the continuous-shooting time interval, that is, a time interval between a time at which an N^{th} image is taken and a time at which an (N+1)^{th} image is taken. The image sensor may be controlled, according to the continuous-shooting time interval, to obtain the original image data, and store the original image data in the at least one buffering storage space in a sequential order, to implement continuous shooting.

In some exemplary embodiments of the present disclosure, as shown in FIG. 6, the displaying image data generated according to the original image data may further include:

S602: Generate corresponding intermediate image data according to the original image data, store the intermediate image data in the at least one buffering storage space, and generate image data according to the intermediate image data.

S604: Delete the original image data in the at least one buffering storage space, and display the image data generated according to the intermediate image data.

In some exemplary embodiments of the present disclosure, after original data of any image is stored in the at least one buffering storage space, corresponding intermediate image data may be generated according to the original data. Generally, the intermediate image data may be data in a YUV format (a color encoding format). After the intermediate image data is generated, the intermediate image data may be correspondingly stored in the at least one buffering storage space. In addition, corresponding image data may be generated according to the intermediate image data. In some exemplary embodiments of the present disclosure, the image data generated acceding to the intermediate image data may be RGB image data. Finally, the corresponding original image data may be deleted in the at least one buffering storage space, to release storage space of the at least one buffering storage space.

In some exemplary embodiments of the present disclosure shown in FIG. 7, after a step of deleting the original image data in the at least one buffering storage space, a method for photographing may further include:

S702: Generate corresponding target image data according to intermediate image data, and store the target image data in the at least one buffering storage space.

S704: Delete the intermediate image data in the at least one buffering storage space.

In some exemplary embodiments of the present disclosure, after intermediate image data (in some exemplary embodiments of the present disclosure, data in a YUV format) of any image is stored in the at least one buffering storage space, corresponding target image data may be generated according to the intermediate image data. Generally, the target image data may be an image file in a JPEG (Joint Photographing Experts Group, which is a common image format) format. After the target image data is generated, the target image data may be correspondingly stored in the at least one buffering storage space. In addition, the corresponding intermediate image data may be deleted in the at least one buffering storage space, to release storage space of the at least one buffering storage space.

The target image data (that is, data in the JPEG format) is only used for storage, and the target image data does not need to be displayed.

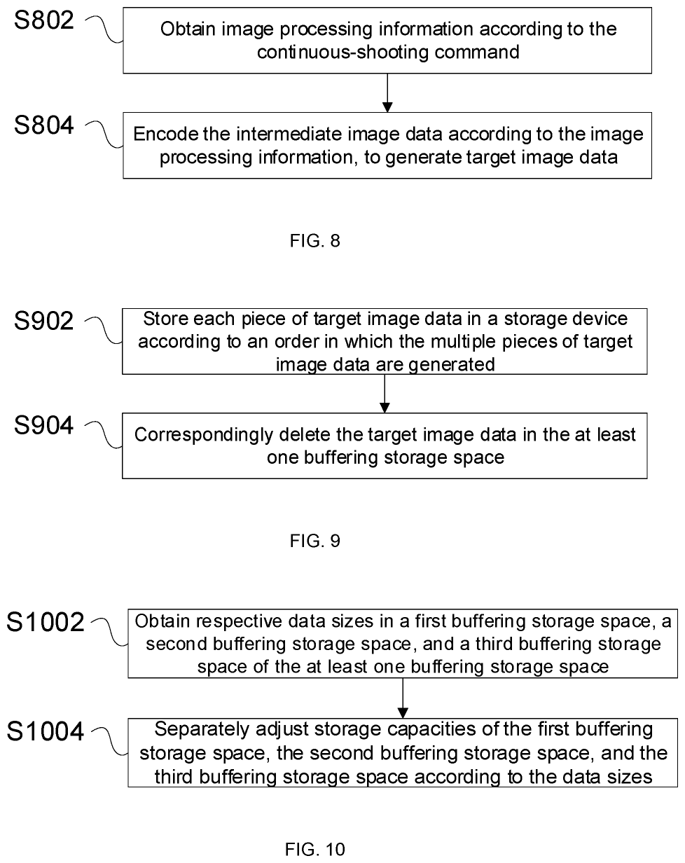

In some exemplary embodiments of the present disclosure, as shown in FIG. 8, a method for photographing may further include:

S802: Obtain image processing information according to the continuous-shooting command.

S804: Encode the intermediate image data according to the image processing information, to generate target image data.

In some exemplary embodiments of the present disclosure, the continuous-shooting command may include the image processing information, and may include an imaging direction (for example, a forward direction, a reverse direction, a horizontal direction, a vertical direction, or a mirror flip) of the target image data. The processor of the photographing apparatus may encode the intermediate image data according to the image processing information, and may finally obtain the target image data in compliance with the image processing information.

In some exemplary embodiments of the present disclosure, as shown in FIG. 9, a method for photographing may further include:

S902: Store each piece of target image data in a storage device according to an order in which the multiple pieces of target image data are generated.

S904: Correspondingly delete the target image data in the at least one buffering storage space.

In some exemplary embodiments of the present disclosure, the multiple pieces of target image data in the at least one buffering storage space are stored in the storage device in a sequential order according to the order in which the multiple pieces of target image data are generated. In some exemplary embodiments of the present disclosure, compared with the at least one buffering storage space (the RAM), the memory has a relatively low data write speed. Therefore, as a continuous-shooting process is performed, obtained target image data may accumulate in the at least one buffering storage space. A to-be-stored queue may be generated based on a time sequence (that is, a sequential order in which the shots are taken) in which the multiple pieces of target image data are generated. In addition, the multiple pieces of target image data may be stored in the storage device in a sequential order based on the to-be-stored queue. Each time after a piece of target image data in the queue is successfully stored in the storage device, the piece of target image data may be deleted in the queue to release space of the at least one buffering storage space.

In some exemplary embodiments of the present disclosure, the at least one buffering storage space may include a first buffering storage space, a second buffering storage space and a third buffering storage space. The original image data may be stored in the first buffering storage space, the intermediate image data may be stored in the second buffering storage space, and the target image data may be stored in the third buffering storage space.

In some exemplary embodiments of the present disclosure, the buffering storage space may include a first buffering storage space, which may be denoted as a RAW buffer; a second buffering storage space, which may be denoted as a YUV buffer; and a third buffering storage space, which may be denoted as a JPEG buffer. The first buffering storage space (the RAW buffer) may be configured to buffer the original image data (RAW), the second buffering storage space (the YUV buffer) may be configured to buffer the intermediate image data (YUV), and the third buffering storage space may be configured to buffer the target image data (JPEG).

The third buffering storage space may be obtained by partitioning the RAM, or may be obtained by partitioning external storage space such as an HDD and/or an SD card.

In some exemplary embodiments of the present disclosure, as shown in FIG. 10, a method for photographing may further include:

S1002: Obtain respective data sizes in a first buffering storage space, a second buffering storage space and a third buffering storage space of the at least one buffering storage space.

S1004: Separately adjust storage capacities of the first buffering storage space, the second buffering storage space and the third buffering storage space according to the data sizes.

In some exemplary embodiments of the present disclosure, the size of corresponding image data in the first buffering storage space, the second buffering storage space and the third buffering storage space may be monitored in real time, and the storage capacities of the first buffering storage space, the second buffering storage space and the third buffering storage space may be dynamically adjusted according to the size of the corresponding image data. In some exemplary embodiments of the present disclosure, if a size of original image data in the first buffering storage space is relatively small, and the first buffering storage space is relatively idle, a storage capacity of the first buffering storage space may be correspondingly reduced; if a size of target image data in the third buffering storage space is relatively large, and the third buffering storage space is almost full, a storage capacity of the third buffering storage space may be correspondingly increased, to ensure utilization efficiency of space of the at least one buffering storage space.

In some exemplary embodiments of the present disclosure, a step of obtaining the original image data may include: fixing an image photographing parameter, and obtaining the original image data according to the image photographing parameter.

In some exemplary embodiments of the present disclosure, when the original image data is obtained, the at least one image photographing parameter may be first fixed, and the original image data may be obtained according to the fixed image photographing parameter. This may ensure that multiple images obtained through continuous shooting have a consistent style, and avoid a case in which a continuous shooting speed is lowered due to wastes in performance caused by determining an at least one image photographing parameter for each photographed image during a continuous-shooting process.

In some exemplary embodiments of the present disclosure, the at least one image photographing parameter includes at least one of: an image exposure parameter, an image focus parameter, or an image white balance parameter.

In some exemplary embodiments of the present disclosure, the at least one image photographing parameter may generally include the image exposure parameter. The exposure parameter affects image exposure (brightness) during imaging. The at least one image photographing parameter may further include the image focus parameter. The image focus parameter affects a focal point position of a photographed object in the target image data. The at least one image photographing parameter may further include the image white balance parameter. The image white balance parameter affects an overall color and tone of an obtained image.

In some exemplary embodiments of the present disclosure, a step of displaying image data generated according to the original image data may further include: continuously obtaining real-time image data; and displaying the real-time image data in the first display area, and displaying the image data in the second display area.

In some exemplary embodiments of the present disclosure, the display screen may include the first display area and the second display area. The real-time image data may be displayed in the first display area, thereby implementing a Live view function. The image data may be displayed in the second display area thereby implementing a Quick view function. In some exemplary embodiments of the present disclosure, the second display area may be within the first display area.

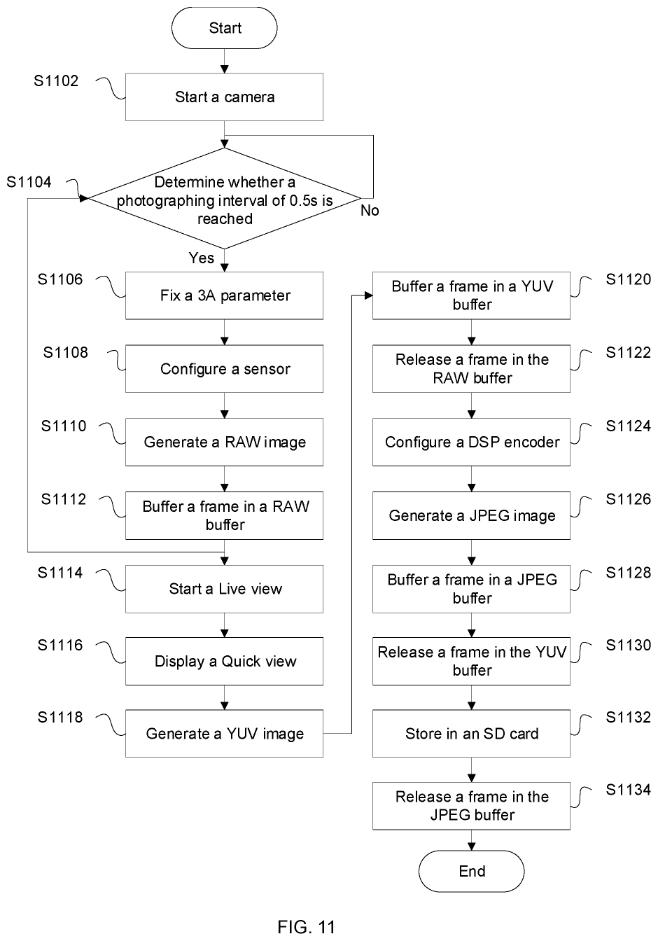

In some exemplary embodiments of the present disclosure shown in FIG. 11, a method for photographing of a continuous shooting with a 0.5 s time interval may include:

S1102: Start a camera.

In this step, when a continuous-shooting command is received, the camera is started, and a Live view may be displayed on a screen. In addition, a sensor (an image sensor) may start to detect a 3 A parameter. The 3 A parameter may be at least one of: an image exposure parameter, an image focus parameter, or an image white balance parameter.

S1104: Determine whether a time interval of 0.5 s is reached. When a determining result is no, S1104 is performed again. When a determining result is yes, S1106 is performed.

In this step, the time interval of 0.5 s may be determined according to the continuous-shooting command. Certainly, there may be a smaller time interval such as 0.3 s, or a larger time interval such as 0.8 s.

S1106: Fix the 3 A parameter.

In this step, before a first image is taken, the 3 A parameter may be first fixed, to ensure a consistent style of images.

S1108: Configure a sensor.

In this step, after the 3 A parameter is fixed, the image sensor (namely, the sensor) may be configured according to the fixed 3 A parameter, to control the sensor to obtain original image data by using the fixed 3 A parameter.

S1110: Generate a RAW image.

In this step, the sensor obtains and generates the original image data, that is, the RAW image, according to the fixed 3 A parameter.

S1112: Buffer a frame in a RAW buffer, and perform S1104 again.

In this step, a RAM is partitioned according to the continuous-shooting command to obtain an at least one buffering storage space. The at least one buffering storage space may include a first buffering storage space, a second buffering storage space and a third buffering storage space. The first buffering storage space is the RAW buffer. The original image data RAW image obtained by the sensor may be buffered in the RAW buffer.

S1114: Start a Live view.

In this step, a real-time image obtained by the sensor may be continuously displayed in a first area of a display screen.

S1116: Display a Quick view.

In this step, a Quick view image generated according to the obtained RAW image may be displayed in a second area of the display screen.

S1118: Generate a YUV image.

In this step, a corresponding YUV image may be generated according to the RAW image buffered in the RAW buffer.

S1120: Buffer a frame in a YUV buffer.

In this step, the generated YUV image may be buffered in a second buffering storage space of the buffering storage space, namely, the YUV buffer.

S1122: Release a frame in the RAW buffer.

In this step, after the generated YUV image is buffered in the YUV buffer, a corresponding RAW image may be correspondingly deleted in the RAW buffer, to release space.

S1124: Configure a DSP encoder.

In this step, the DSP encoder may be configured according to image processing information in the continuous-shooting command, to control the DSP encoder to encode the YUV image.

S1126: Generate a JPEG image.

In this step, after the YUV image is encoded by the DSP encoder, a JPEG image of target image data may be obtained.

S1128: Buffer a frame in a JPEG buffer.

In this step, the generated JPEG image may be buffered in a third buffering storage space of the buffering storage space, namely, the JPEG buffer.

S1130: Release a frame in the YUV buffer.

In this step, after the generated JPEG image is buffered in the JPEG buffer, a corresponding YUV image may be correspondingly deleted in the YUV buffer, to release space.

S1132: Store in an SD card.

In this step, JPEG images may be stored, according to a sequential order in which the JPEG images are generated, in the SD card in a queue in a sequential order.

S1134: Release a frame in the JPEG buffer.

In this step, after the JPEG image is stored in the SD card, the corresponding JPEG image may be correspondingly deleted in the JPEG buffer, to release space.

In some exemplary embodiments of the present disclosure, when a timing interval of 0.5 s is reached, the camera may start the following photographing procedure: fixing a 3 A parameter; stopping a Live view; configuring a sensor; generating a RAW image; sending the generated RAW image to a RAW buffer obtained by partitioning the RAM for buffering; starting the Live view; displaying a Quick view on a LCD display; generating a YUV image according to the RAW image; sending the generated YUV image to a YUV buffer for buffering; releasing RAW image data generated in the current photographing procedure from a RAW buffer; configuring a DSP encoder (control an encoding scheme, and is configured to perform encoding on image data obtained in different photographing modes such as front photographing, vertical photographing, and backward photographing); generating a JPEG image by using the YUV image; sending the generated JPEG image to a JPEG buffer for buffering; releasing the YUV image generated in the current photographing procedure from the YUV buffer; storing the JPEG image generated in the photographing procedure in a SD card; and finally releasing the JPEG image generated in the current photographing procedure from the JPEG buffer.

The RAW buffer, the YUV buffer and the JPEG buffer may each be a storage area (a capacity size of each of the three areas may be set or may be dynamically adjusted according to an actual storage status) that has a fixed size and may be allocated in a RAM when the camera starts a 0.5 s timing continuous-shooting function. In some exemplary embodiments of the present disclosure, the storage area may buffer a plurality of RAW image data, YUV image data and JPEG image data.

A time required for the foregoing procedure may exceed a time interval of 0.5 s. In some exemplary embodiments of the present disclosure, a data buffering mechanism is used, and multiple steps of the foregoing photographing procedure are processed in parallel. After the RAW image is sent to the RAW buffer, a next photographing procedure may be started immediately after, that is, the next photographing procedure may be started before the current photographing procedure is totally completed. A method in which data is buffered in a buffer is used, so that different steps of multiple photographing procedures may be completely independently performed, thus execution of a step in one photographing procedure will not affect the execution of other steps in another photographing procedure that is started at a different time.

In descriptions of this application, the term “multiple” refers to two or more than two. Unless otherwise clearly specified, an orientation or position relationship indicated by the terms “upper”, “lower”, and the like is based on the orientation or position relationship described in the drawings, is merely for convenience of describing this application and simplifying the description, rather than indicating or implying that a device or an element referred to should have a specific orientation and be constructed and operated in a specific orientation, and therefore cannot be construed as a limitation on this application. The terms “connection”, “installation”, “fixation”, and the like should be understood in a broad sense. For example, “connection” can be a fixed connection, a detachable connection, or an integral connection, can be a direct connection or an indirect connection performed through an intermediate medium. A person of ordinary skill in the art may understand specific meanings of the foregoing terms in this application based on a specific situation.

In descriptions of this application, descriptions of the terms “one embodiment”, “some embodiments”, “a specific embodiment” or the like mean that a specific feature, structure, material, or characteristic described in combination with the embodiment(s) or example(s) is included in at least one embodiment or example of this application. In this application, schematic expressions of the foregoing terms do not necessarily refer to the same embodiment or example. Moreover, the described specific feature, structure, material, or characteristic may be combined in any suitable manner in any one or more embodiments or examples.

A person of ordinary skill in the art can understand that all or some of the steps in the methods of the foregoing exemplary embodiments may be implemented by a program instructing relevant hardware. The program may be stored in a non-transitory computer-readable storage medium. When executed, the program may include one of the steps of the exemplary method embodiment or a combination thereof. In some exemplary embodiments of the present disclosure, the photographing apparatus includes a non-transitory storage medium. The non-transitory storage medium stores a set of instructions for controlling the photographing apparatus. During operation, the processor executes the set of instructions stored on the non-transitory storage medium to perform the foregoing steps to control the photographing apparatus according to some exemplary embodiments of the present disclosure.

In addition, functional units in some exemplary embodiments of this disclosure may be integrated into one processing module, or each of the units may exist alone physically, or two or more units may be integrated into one module. The foregoing integrated module may be implemented in a form of hardware, or may be implemented in a form of a functional module of software. The integrated module, if implemented in the form of a functional module of software and sold or used as an independent product, may be stored in a non-transitory computer-readable storage medium.

The aforementioned non-transitory storage medium may be a read-only memory, a magnetic disk, or an optical disc. Although the exemplary embodiments of this disclosure have been shown and described above, it may be understood that the aforementioned embodiments are exemplary and should not be construed as limiting this disclosure. A person of ordinary skill in the art can make changes, modifications, replacements, and variants on the exemplary embodiments within the scope of this disclosure.

The foregoing descriptions are merely some exemplary embodiments of the present disclosure, and are not intended to limit this application. For a person skilled in the art, various modifications and changes may be made to this application. Any modifications, equivalent replacements, improvements, and the like made within the spirit and principle of this application shall fall within the protection scope of this application.

What is claimed is:

1. A photographing apparatus comprising:
at least one image sensor;
at least one display screen;
at least one transitory storage medium;
at least one non-transitory storage medium, storing at least one set of instructions;
at least one processor in communication with the at least one transitory storage medium and the at least one non-transitory storage medium, the at least one image sensor, and the at least one display screen, wherein during operation, the at least one processor execute the at least one set of instructions to:
receive a continuous-shooting command,
partition the transitory storage medium according to the continuous-shooting command to obtain an at least one buffering storage space,
control the image sensor to obtain original image data,
store the original image data in the at least one buffering storage space, and
control the display screen to display image data generated according to the original image data.

2. The photographing apparatus according to claim 1, wherein to control the image sensor to obtain the original image data, the at least one processor further execute the set of instructions to:
obtain a continuous-shooting time interval according to the continuous-shooting command; and
control the image sensor to obtain the original image data according to the time interval.

3. The photographing apparatus according to claim 1, wherein the at least one processor further executes the set of instructions to:
generate corresponding intermediate image data according to the original image data;
store the intermediate image data in the at least one buffering storage space;
generate image data according to the intermediate image data;
delete the original image data in the at least one buffering storage space; and
display the image data generated according to the intermediate image data.

4. The photographing apparatus according to claim 3, wherein the at least one processor further executes the set of instructions to:
generate corresponding target image data according to the intermediate image data;
store the target image data in the at least one buffering storage space; and
delete the intermediate image data in the at least one buffering storage space.

5. The photographing apparatus according to claim 4 further comprising:
an encoder, in communication with the at least one processor,
wherein to generate the corresponding target image data according to the intermediate image data, the at least one processor further executes the set of instructions to:
obtain image processing information according to the continuous-shooting command; and
control, according to the image processing information, the encoder to encode the intermediate image data, to generate the target image data.

6. The photographing apparatus according to claim 4, wherein the target image data includes multiple pieces of data, and
the at least one processor further executes the set of instructions to:
store the multiple pieces of data in the non-transitory storage medium according to a sequential order in which the multiple pieces of data are generated; and
delete the target image data in the at least one buffering storage space.

7. The photographing apparatus according to claim 4, wherein the at least one buffering storage space includes:
a first buffering storage space;
a second buffering storage space; and
a third buffering storage space,
wherein the original image data is stored in the first buffering storage space, the intermediate image data is stored in the second buffering storage space, and the target image data is stored in the third buffering storage space.

8. The photographing apparatus according to claim 7, wherein the at least one processor further executes the set of instructions to:
obtain respective data sizes in the first buffering storage space, the second buffering storage space and the third buffering storage space; and
separately adjust storage capacities of the first buffering storage space, the second buffering storage space and the third buffering storage space according to the data sizes.

9. The photographing apparatus according to claim 1, wherein to control the image sensor to obtain original image data, the at least one processor further executes the set of instructions to:
fix at least one image photographing parameter of the image sensor; and
obtain the original image data according to the at least one image photographing parameter.

10. The photographing apparatus according to claim 1, wherein:
the display screen includes a first display area and a second display area; and
the at least one processor further executes the set of instructions to:
control the image sensor to continuously obtain real-time image data;
control the display screen to display the real-time image data in the first display area; and
control the display screen to display the real-time image data in the second display area.

11. A method for photographing, comprising:
receiving a continuous-shooting command;
partitioning a transitory storage medium of a photographing apparatus according to the continuous-shooting command to obtain an at least one buffering storage space;
obtaining original image data;
storing the original image data in the at least one buffering storage space; and
displaying image data generated according to the original image data.

12. The method according to claim 11, wherein the obtaining of the original image data further includes:
obtaining a continuous-shooting time interval according to the continuous-shooting command; and
obtaining the original image data according to the time interval.

13. The method according to claim 11, wherein the displaying image data generated according to the original image data includes:
generating corresponding intermediate image data according to the original image data;
storing the intermediate image data in the at least one buffering storage space;
generating image data according to the intermediate image data; and
deleting the original image data in the at least one buffering storage space; and
displaying the image data generated according to the intermediate image data.

14. The method according to claim 13 further comprising:
generating corresponding target image data according to the intermediate image data;
storing the target image data in the at least one buffering storage space; and
deleting the intermediate image data in the at least one buffering storage space.

15. The method according to claim 14, wherein the generating corresponding target image data according to the intermediate image data further includes:
obtaining image processing information according to the continuous-shooting command; and
encoding the intermediate image data according to the image processing information to generate the target image data.

16. The method according to claim 14, wherein the target image data includes multiple pieces of data, the method further comprising:
storing the multiple pieces of data in a non-transitory storage medium according to a sequential order in which the multiple pieces of data are generated; and
deleting the target image data in the at least one buffering storage space.

17. The photographing apparatus according to claim 14, wherein the at least one buffering storage space includes:
a first buffering storage space,
a second buffering storage space, and
a third buffering storage space;
wherein the original image data is stored in the first buffering storage space, the intermediate image data is stored in the second buffering storage space, and the target image data is stored in the third buffering storage space.

18. The method according to claim 17, further comprising:
obtaining respective data sizes in the first buffering storage space, the second buffering storage space and the third buffering storage space; and
separately adjusting storage capacities of the first buffering storage space, the second buffering storage space and the third buffering storage space according to the data sizes.

19. The method according to claim 11, wherein the obtaining of original image data includes:
fixing at least one image photographing parameter; and
obtaining the original image data according to the at least one image photographing parameter.

20. The method according to claim 19, wherein the at least one image photographing parameter includes at least one of:
an image exposure parameter, an image focus parameter, or an image white balance parameter.
